(19) United States
(12) Patent Application Publication
(10) Pub. No.: US 2026/0036852 A1
(43) Pub. Date: Feb. 5, 2026

(54) CHOLESTERIC LIQUID CRYSTAL DISPLAY DEVICE

(71) Applicant: Iris Optronics Co., Ltd., Tainan City (TW)

(72) Inventors: Ching Shan LIN, Kaohsiung City (TW); Tsung Lun TSAI, Tainan City (TW); Wu Chang YANG, Tainan City (TW); Chi Chang LIAO, Tainan City (TW)

(21) Appl. No.: 19/286,235

(22) Filed: Jul. 30, 2025

Related U.S. Application Data
(60) Provisional application No. 63/678,530, filed on Aug. 1, 2024.

(30) Foreign Application Priority Data
Jul. 17, 2025 (TW) 114127004

(51) Int. Cl. G02F 1/1343; G02F 1/00; G02F 1/1333

(52) U.S. Cl. CPC G02F 1/134309; G02F 1/0018; G02F 1/13338; G02F 2201/50; G02F 2202/28

(57) ABSTRACT

A cholesteric liquid crystal display device includes a liquid crystal module and a touch module. The liquid crystal module includes a flat layer. The touch module is disposed on a surface of the flat layer of the liquid crystal module. The touch module includes a first electrode layer, a filter-side substrate layer, a second electrode layer, a first optical transparent adhesive layer and a cover substrate. The first electrode layer is connected to the flat layer of the liquid crystal module. The filter-side substrate is connected to the first electrode layer. The second electrode layer is connected to the filter-side substrate. The first optical transparent adhesive layer is connected to the second electrode layer. The cover substrate is connected to the first optical transparent adhesive layer. Therefore, the reflectivity and contrast of the cholesteric liquid crystal display device can be enhanced.

### RELATED APPLICATIONS

This application claims priority to U.S. Provisional Application Ser. No. 63/678,530 filed Aug. 1, 2024, and Taiwan Application Serial Number 114127004, filed Jul. 17, 2025, the disclosures of which are incorporated herein by reference in their entireties.

### BACKGROUND

### Technical Field

The present disclosure relates to a liquid crystal display device. More particularly, the present disclosure relates to a cholesteric liquid crystal display device which can improve the reflection and contrast thereof.

### Description of Related Art

Cholesteric liquid crystal display device (Ch-LCD) is based on helical structure characteristics of cholesteric liquid crystal molecules, and the alignment direction of the cholesteric liquid crystal molecules is controlled by applying an electric field so as to achieve the display effect through selective reflection. Because the cholesteric liquid crystal display device has a bistability characteristic, namely the planar state and the focal conic state, the cholesteric liquid crystal display device can remain stable without the electric field. Therefore, the cholesteric liquid crystal display device has the advantage of low power consumption, which is allowing long-term display and reducing energy usage.

However, in the conventional cholesteric liquid crystal display device, the number of interfaces thereof would increase if a touch module is provided, thereby affecting reflectivity and contrast. Please refer to FIG. 9, FIG. 10 and FIG. 11, FIG. 9 is a cross-sectional schematic view of the conventional cholesteric liquid crystal display device 900, FIG. 10 is a partial cross-sectional schematic view of the region 10 according to the touch module 920 of FIG. 9, and FIG. 11 is a top schematic view of the second electrode layer 925, the second thin film layer 926 and the third electrode layer 927 of FIG. 10. The conventional cholesteric liquid crystal display device 900 includes a liquid crystal module 910 and the touch module 920. The touch module 920 includes a first optical transparent adhesive layer 921, a first electrode layer 922, a first thin film layer 923, a second optical transparent adhesive layer 924, a second electrode layer 925, a second thin film layer 926, a third electrode layer 927, a third optical transparent adhesive layer 928 and a cover substrate 929 stacked in order from bottom to top. As shown in FIG. 9 to FIG. 11, the conventional cholesteric liquid crystal display device 900 has higher light loss during transmission due to the excessive number of layers of the liquid crystal module 910 and the touch module 920, resulting in degraded optical quality of the cholesteric liquid crystal display device 900.

In view of this, how to improve the reflectivity and contrast of the cholesterol liquid crystal display device with a touch module has become the goal that related industries strive for.

### SUMMARY

According to one aspect of the present disclosure, a cholesteric liquid crystal display device includes a liquid crystal module and a touch module. The liquid crystal module includes a flat layer. The touch module is disposed on a surface of the flat layer of the liquid crystal module. The touch module includes a first electrode layer, a filter-side substrate, a second electrode layer, a first optical transparent adhesive layer and a cover substrate. The first electrode layer is connected to the flat layer of the liquid crystal module. The filter-side substrate is connected to the first electrode layer, so that the first electrode layer is located between the filter-side substrate and the liquid crystal module. The second electrode layer is connected to the filter-side substrate, so that the filter-side substrate is located between the second electrode layer and the first electrode layer. The first optical transparent adhesive layer is connected to the second electrode layer, so that the second electrode layer is located between the first optical transparent adhesive layer and the filter-side substrate. The cover substrate is connected to the first optical transparent adhesive layer, so that the first optical transparent adhesive layer is located between the cover substrate and the second electrode layer.

According to another aspect of the present disclosure, a cholesteric liquid crystal display device includes a liquid crystal module and touch module. The liquid crystal module includes a flat layer. The touch module is disposed on a surface of the flat layer of the liquid crystal module. The touch module includes a filter-side substrate, a first electrode layer, an optical transparent adhesive layer, a second electrode layer and a cover substrate. The filter-side substrate is connected to the flat layer of the liquid crystal module. The first electrode layer is connected to the filter-side substrate, so that the filter-side substrate is located between the first electrode layer and the liquid crystal module. The optical transparent adhesive layer is connected to the first electrode layer, so that the first electrode layer is located between the optical transparent adhesive layer and the filter-side substrate. The second electrode layer is connected to the optical transparent adhesive layer, so that the optical transparent adhesive layer is located between the second electrode layer and the first electrode layer. The cover substrate is connected to the second electrode layer, so that the second electrode layer is located between the cover substrate and the optical transparent adhesive layer.

### BRIEF DESCRIPTION OF THE DRAWINGS

The present disclosure can be more fully understood by reading the following detailed description of the embodiment, with reference made to the accompanying drawings as follows:

FIG. 1 is a cross-sectional schematic view of a cholesteric liquid crystal display device according to the 1st embodiment of the present disclosure.

FIG. 2 is a partial cross-sectional schematic view of the region 2 according to the touch module of FIG. 1.

FIG. 3 is a top schematic view of the first electrode layer, the filter-side substrate and the second electrode layer of FIG. 2.

FIG. 4 is a cross-sectional schematic view of the cholesteric liquid crystal display device according to the 2nd embodiment of the present disclosure.

FIG. 5 is a partial cross-sectional schematic view of the region 5 according to the touch module of FIG. 4.

FIG. 6 is a cross-sectional schematic view of the cholesteric liquid crystal display device according to the 3rd embodiment of the present disclosure.

FIG. 7 is a partial cross-sectional schematic view of the region 7 according to the touch module of FIG. 6.

FIG. 8 is a three-dimensional schematic view of the filter-side substrate, the first electrode layer, the optical transparent adhesive layer, the second electrode layer and the cover substrate of FIG. 7.

FIG. 9 is a cross-sectional schematic view of the conventional cholesteric liquid crystal display device.

FIG. 10 is a partial cross-sectional schematic view of the region 10 according to the touch module of FIG. 9.

FIG. 11 is a top schematic view of the second electrode layer, the second thin film layer and the third electrode layer of FIG. 10.

### DETAILED DESCRIPTION

The present disclosure will be further exemplified by the following specific embodiments. However, the embodiments can be applied to various inventive concepts and can be embodied in various specific ranges. The specific embodiments are only for the purposes of description, and are not limited to these practical details thereof. Besides, for the sake of simplicity of the drawings, some conventional or commonly used structures and elements are drawn only schematically in the drawings; the duplicated elements may be denoted by the same number or similar number.

In the present disclosure, when a component (or mechanism, or module, etc.) is described as being “connected” or “disposed” to another component, it may refer to the component being directly connected or directly disposed to the other component, or it may refer to the component being indirectly connected or indirectly disposed to the other component, meaning that there may be other components between the said component and the other component. Only when it is explicitly stated that a component is “directly connected” or “directly disposed” to another component does it mean that no other component is interposed between them.

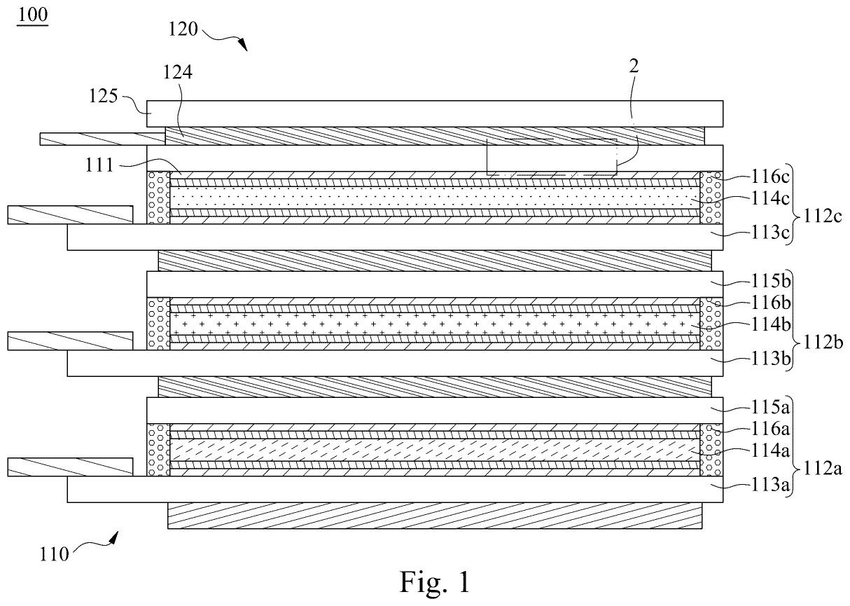

Please refer to FIG. 1. FIG. 1 is a cross-sectional schematic view of a cholesteric liquid crystal display device 100 according to the 1st embodiment of the present disclosure. The cholesteric liquid crystal display device 100 includes a liquid crystal module 110 and a touch module 120.

In detail, the liquid crystal module 110 includes a flat layer 111. The liquid crystal module 110 can further include three multilayer structures 112a, 112b, 112c stacked on each other. Each of the multilayer structures 112a, 112b located at the bottom layer and the middle layer can include a lower substrate 113a, 113b, a pixel layer 114a, 114b, an upper substrate 115a, 115b and the sealing component 116a, 116b. Each pixel layer 114a, 114b is connected to each lower substrate 113a, 113b. Each upper substrate 115a, 115b is connected to each pixel layer 114a, 114b, so that each pixel layer 114a, 114b is located between each upper substrate 115a, 115b and each lower substrate 113a, 113b. Each sealing component 116a, 116b is disposed between each upper substrate 115a, 115b and each lower substrate 113a, 113b, and surrounds the pixel layer 114a, 114b. The multilayer structure 112c located at the top layer can include a lower substrate 113c, a pixel layer 114c and a sealing component 116c. The pixel layer 114c and sealing component 116c are respectively connected the lower substrate 113c. The sealing component 116c surrounds the pixel layer 114c. The flat layer 111 can be connected the pixel layer 114c of the multilayer structure 112c which is the top layer. The aforementioned connection can be achieved by the optical transparent adhesive layer or optical color adhesive layer. Furthermore, when the optical color adhesive layer is applied, the effects of absorbing or filtering the stray light can be further achieved.

Moreover, the pixel layer 114a of the multilayer structure 112a which is the bottom layer can be a red pixel layer, the pixel layer 114b of the multilayer structure 112b which is the middle layer can be a green pixel layer, the pixel layer 114c of the multilayer structure 112c which is the top layer can be a blue pixel layer, thereby achieving good displaying effect. When the pixel layer 114a, 114b, 114c of the three multilayer structures 112a, 112b, 112c are arranged as the aforementioned arrangement, a pink optical adhesive layer can be disposed between the multilayer structures 112a, 112b (which are the bottom layer and the middle layer), a yellow optical adhesive layer can be disposed between the multilayer structures 112b, 112c (which are the middle layer and the top layer), so that specific color of the stray light can be filtered. It should be noted that the number of the multilayer structures of the liquid crystal module 110 can be one, the pixel layer of the one multilayer structure can be a red pixel layer, green pixel layer or blue pixel layer. Therefore, the number of the multilayer structures and the color of the pixel layer of the present disclosure will not be limited thereto.

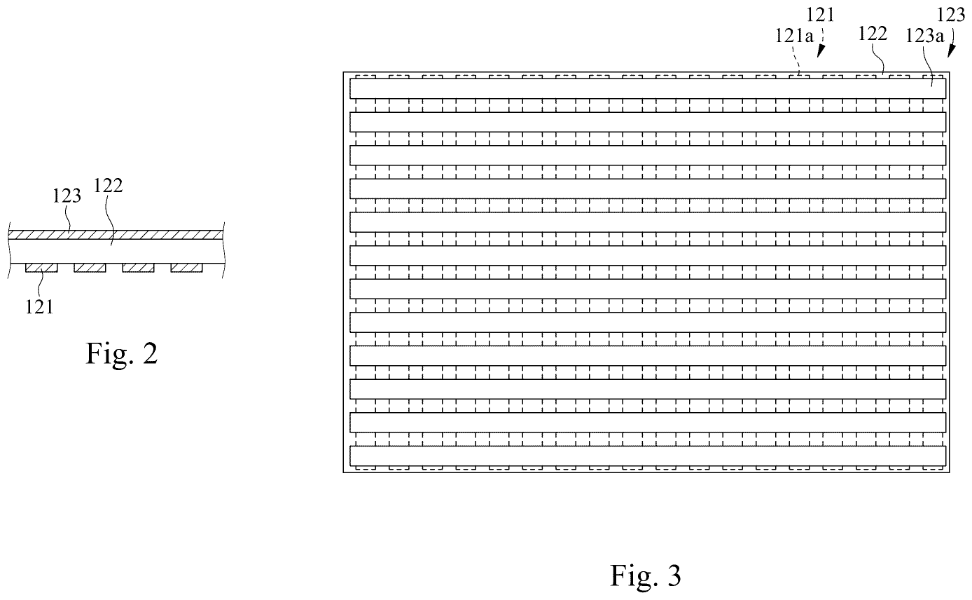

Please refer to both FIG. 1 and FIG. 2. FIG. 2 is a partial cross-sectional schematic view of the region 2 according to the touch module 120 of FIG. 1. The touch module 120 is disposed on a surface (its reference numeral is omitted) of the flat layer 111 of the liquid crystal module 110. The touch module 120 includes a first electrode layer 121, a filter-side substrate 122, a second electrode layer 123, a first optical transparent adhesive layer 124 and a cover substrate 125. The first electrode layer 121 is connected to the flat layer 111 of the liquid crystal module 110. The filter-side substrate 122 is connected to the first electrode layer 121, so that the first electrode layer 121 is located between the filter-side substrate 122 and the liquid crystal module 110. The second electrode layer 123 is connected to the filter-side substrate 122, so that the filter-side substrate 122 is located between the second electrode layer 123 and the first electrode layer 121. The first optical transparent adhesive layer 124 is connected to the second electrode layer 123, so that the second electrode layer 123 is located between the first optical transparent adhesive layer 124 and the filter-side substrate 122. The cover substrate 125 is connected to the first optical transparent adhesive layer 124, so that the first optical transparent adhesive layer 124 is located between the cover substrate 125 and the second electrode layer 123. Therefore, the number of total layers of the touch module can be decreased, when the external light incident to the cholesteric liquid crystal display device 100, the loss of light caused by transmission can be reduced, thereby improving the reflectivity and contrast of the cholesteric liquid crystal display device 100.

Please refer to FIG. 3. FIG. 3 is a top schematic view of the first electrode layer 121, the filter-side substrate 122 and the second electrode layer 123 of FIG. 2. The first electrode layer 121 can include a plurality of first conductive bands 121 a. The first conductive bands 121a are arranged in parallel to each other. The second electrode layer 123 includes a plurality of second conductive bands 123a. The second conductive bands 123a are arranged in parallel to each other. The first conductive bands 121a and the second conductive bands 123a are orthogonal to each other. In detail, the first electrode layer 121 can be an emission electrode (Tx) layer, and the second electrode layer 123 can be a receiving electrode (Rx) layer.

The cholesteric liquid crystal display device 100 can further include a driving electrode. The driving electrode can be electrically connected to the first electrode layer 121 and the liquid crystal module 110, respectively. When the first electrode layer 121 and the liquid crystal module 110 share the same driving electrode, the first electrode layer 121 and the liquid crystal module 110 may not overlap during being driven. Furthermore, the cholesteric liquid crystal display device 100 can further include an integrated circuit element. The integrated circuit element is electrically connected to the first electrode layer 121 and the liquid crystal module 110, respectively. In the other words, the circuit of the first electrode layer 121 and the circuit of the liquid crystal module 110 can be integrated into the same integrated circuit element.

The filter-side substrate 122 and the cover substrate 125 can be a glass substrate, a flexible polyester substrate or a polyimide substrate, respectively. The filter-side substrate 122 can include an active matrix structure or a passive matrix structure. Therefore, the material or configuration of the filter-side substrate 122 and the cover substrate 125 can be adjusted to satisfy the different usage needs.

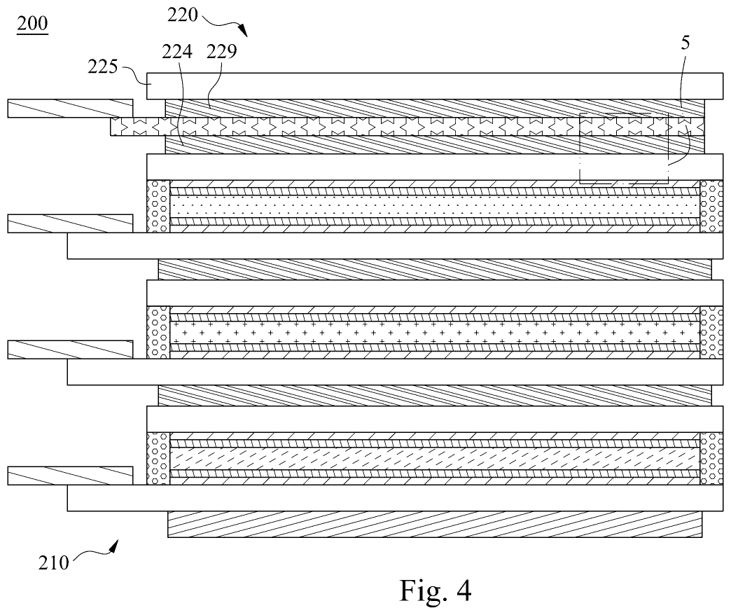

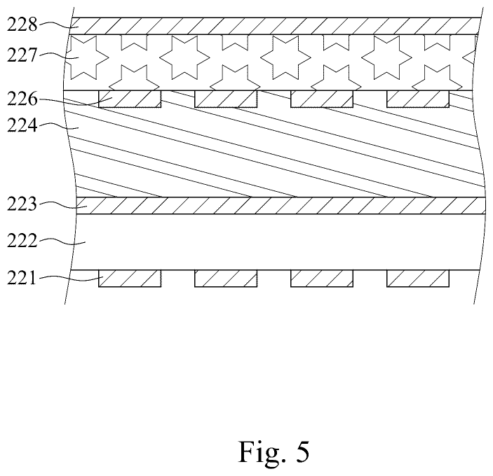

Please refer to FIG. 4 and FIG. 5. FIG. 4 is a cross-sectional schematic view of the cholesteric liquid crystal display device 200 according to the 2nd embodiment of the present disclosure. FIG. 5 is a partial cross-sectional schematic view of the region 5 according to the touch module 220 of FIG. 4.

The cholesteric liquid crystal display device 200 includes a liquid crystal module 210 and a touch module 220. The touch module 220 can include a first electrode layer 221, a filter-side substrate 222, a second electrode layer 223, a first optical transparent adhesive layer 224, a cover substrate 225, a third electrode layer 226, a thin film layer 227, a fourth electrode layer 228 and a second optical transparent adhesive layer 229. The first electrode layer 221, the filter-side substrate 222, the second electrode layer 223, the first optical transparent adhesive layer 224 and the cover substrate 225 of the 2nd embodiment and the first electrode layer 121, the filter-side substrate 122, the second electrode layer 123, the first optical transparent adhesive layer 124 and the cover substrate 125 of the 1st embodiment are the same or similar, and the similarities thereof are not repeated herein.

The third electrode layer 226 can be connected to the first optical transparent adhesive layer 224, so that the first optical transparent adhesive layer 224 is located between the third electrode layer 226 and the second electrode layer 223. The thin film layer 227 can be connected to the third electrode layer 226, so that the third electrode layer 226 is located between the thin film layer 227 and the first optical transparent adhesive layer 224. The fourth electrode layer 228 can be connected to the thin film layer 227, so that the thin film layer 227 is located between the fourth electrode layer 228 and the third electrode layer 226. The second optical transparent adhesive layer 229 can be connected to the fourth electrode layer 228 and the cover substrate 225, so that the fourth electrode layer 228 is located between the second optical transparent adhesive layer 229 and the thin film layer 227, and the second optical transparent adhesive layer 229 is located between the cover substrate 225 and the fourth electrode layer 228. Therefore, the touch module 220 can form a shielding structure to reduce interference, thereby improving the resolution of the touch module 220.

The third electrode layer 226 can include a plurality of third conductive bands. The third conductive bands are arranged in parallel. The fourth electrode layer can include a plurality of fourth conductive bands. The fourth conductive bands are arranged in parallel. The third conductive bands and the fourth conductive bands are orthogonal to each other. In detail, the third electrode layer 226 can be an emission electrode layer, and the fourth electrode layer 228 can be a receiving electrode layer. Therefore, the cholesteric liquid crystal display device 200 of the 2nd embodiment can be applied to the existing drive mode. Configuration of the third conductive bands and the fourth conductive bands in the 2nd embodiment and configuration of the first conductive bands 121 a and the second conductive bands 123a in the 1st embodiment are the same or similar, and the similarities thereof are not repeated herein.

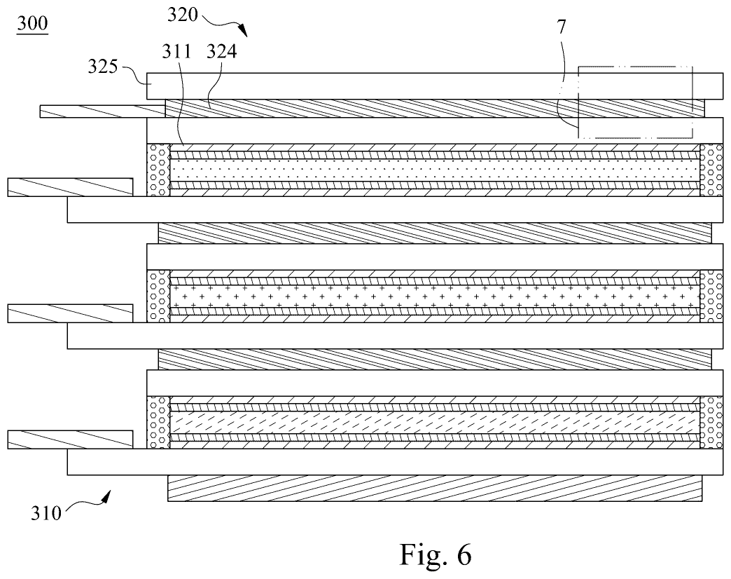

Please refer to FIG. 6. FIG. 6 is a cross-sectional schematic view of the cholesteric liquid crystal display device according to the 3rd embodiment of the present disclosure. The cholesteric liquid crystal display device 300 includes a liquid crystal module 310 and a touch module 320. The liquid crystal module 310 of the 3rd embodiment and the liquid crystal module 110 of the 1st embodiment are the same or similar, and the similarities thereof are not repeated herein.

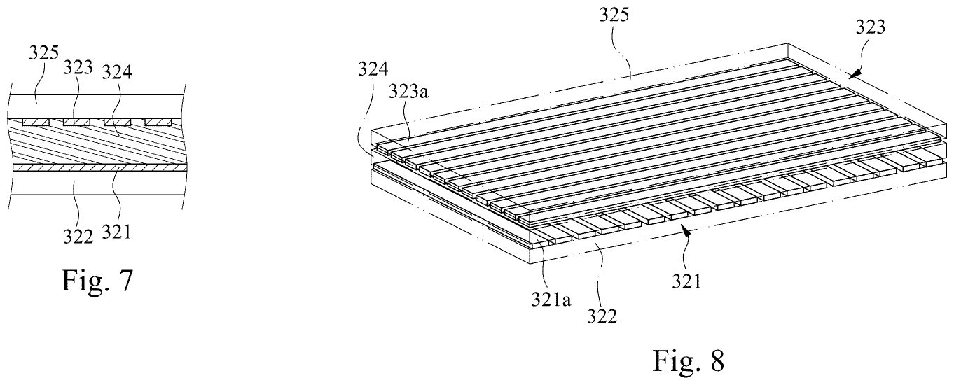

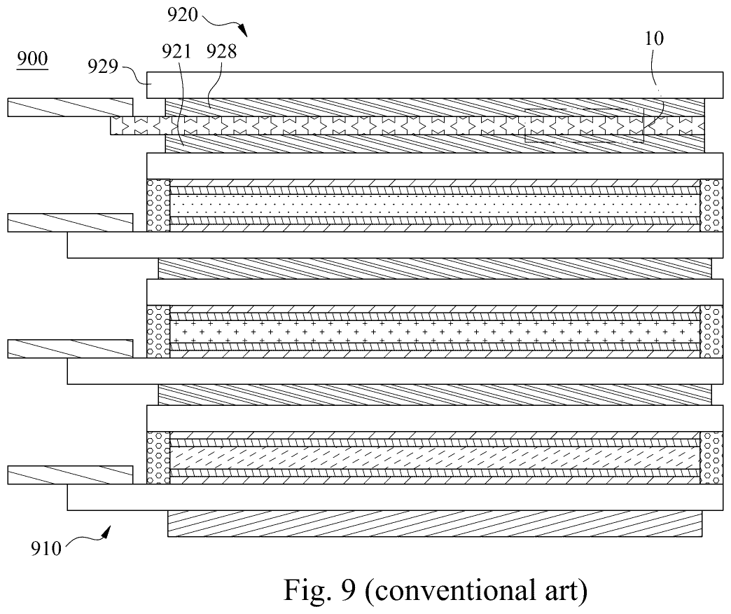

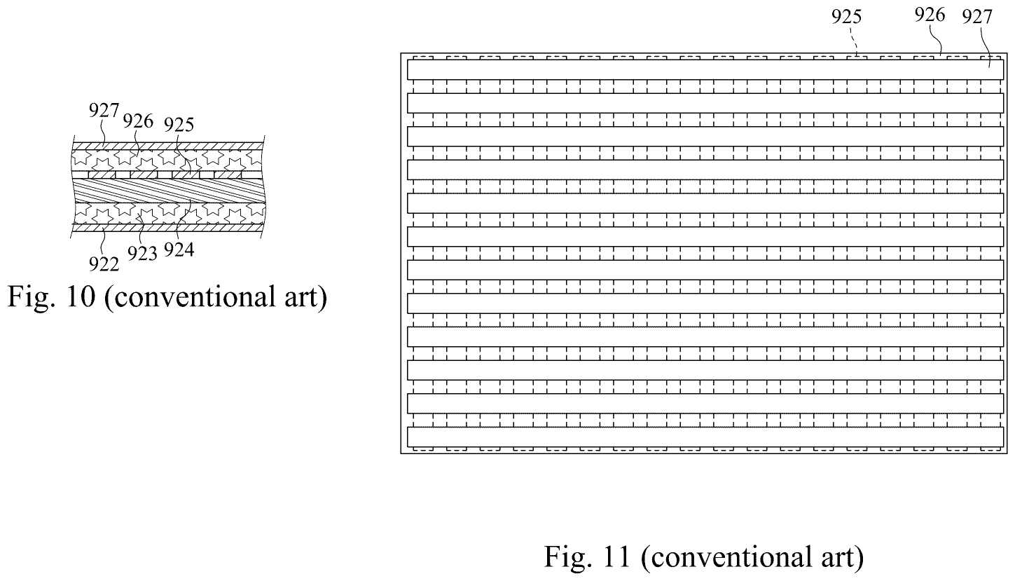

Please refer to both FIG. 6 and FIG. 7. FIG. 7 is a partial cross-sectional schematic view of the region 7 according to the touch module 320 of FIG. 6. The touch module 320 is disposed on the surface of the flat layer 311 of the liquid crystal module 310. The touch module 320 includes a filter-side substrate 322, a first electrode layer 321, an optical transparent adhesive layer 324, a second electrode layer 323 and a cover substrate 325. The filter-side substrate 322 is connected to the flat layer 311 of the liquid crystal module 310. The first electrode layer 321 is connected to the filter-side substrate 322, so that the filter-side substrate 322 is located between the first electrode layer 321 and the liquid crystal module 310. The optical transparent adhesive layer 324 is connected to the first electrode layer 321, so that the first electrode layer 321 is located between the optical transparent adhesive layer 324 and the filter-side substrate 322. The second electrode layer 323 is connected to the optical transparent adhesive layer 324, so that the optical transparent adhesive layer 324 is located between the second electrode layer 323 and the first electrode layer 321. The cover substrate 325 is connected to the second electrode layer 323, so that the second electrode layer 323 is located between the cover substrate 325 and the optical transparent adhesive layer 324. Therefore, the number of total layers of the touch module 320 can decrease, when the outside light incident to the cholesteric liquid crystal display device 300, the loss of light caused by penetration can be reduced, thereby improving the reflectivity and contrast of the cholesteric liquid crystal display device 300.

Please refer to FIG. 8. FIG. 8 is a three-dimensional schematic view of the filter-side substrate 322, the first electrode layer 321, the optical transparent adhesive layer 324, the second electrode layer 323 and the cover substrate 325 of FIG. 7. The first electrode layer 321 can include a plurality of first conductive bands 321a. The first conductive bands 321 a are arranged in parallel. The second electrode layer 323 can include a plurality of second conductive bands 323a. The second conductive bands 323a are arranged in parallel. The first conductive bands 321a and the second conductive bands 323a are orthogonal to each other. In detail, the first electrode layer 321 a can be a receiving electrode layer, and the second electrode layer 323a can be an emission electrode layer. Therefore, the cholesteric liquid crystal display device 300 of the 3rd embodiment can be applied to the existing drive mode.

In summary, by reducing the number of total layers of touch module of the cholesteric liquid crystal display device of the present disclosure, the liquid crystal module and the touch module can be combined effectively, and the loss of light caused by transmitting multilayer structures can be reduced, thereby improving the reflectivity and contrast of the cholesteric liquid crystal display device. Therefore, the optical quality of the cholesteric liquid crystal display device can be improved.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A cholesteric liquid crystal display device, comprising:
a liquid crystal module comprising a flat layer; and
a touch module disposed on a surface of the flat layer of the liquid crystal module, the touch module comprising:
a first electrode layer connected to the flat layer of the liquid crystal module;
a filter-side substrate connected to the first electrode layer, wherein the first electrode layer is located between the filter-side substrate and the liquid crystal module;
a second electrode layer connected to the filter-side substrate, wherein the filter-side substrate is located between the second electrode layer and the first electrode layer;
a first optical transparent adhesive layer connected to the second electrode layer, wherein the second electrode layer is located between the first optical transparent adhesive layer and the filter-side substrate; and
a cover substrate connected to the first optical transparent adhesive layer, wherein the first optical transparent adhesive layer is located between the cover substrate and the second electrode layer.

2. The cholesteric liquid crystal display device of claim 1, wherein the first electrode layer comprises a plurality of first conductive bands, the first conductive bands are arranged in parallel, the second electrode layer comprises a plurality of second conductive bands, the second conductive bands are arranged in parallel, wherein the first conductive bands and the second conductive bands are orthogonal to each other.

3. The cholesteric liquid crystal display device of claim 1, wherein the touch module further comprises:
a third electrode layer connected to the first optical transparent adhesive layer, wherein the first optical transparent adhesive layer is located between the third electrode layer and the second electrode layer;
a thin film layer connected to the third electrode layer, wherein the third electrode layer is located between the thin film layer and the first optical transparent adhesive layer;
a fourth electrode layer connected to the thin film layer, wherein the thin film layer is located between the fourth electrode layer and the third electrode layer; and
a second optical transparent adhesive layer connected to the fourth electrode layer and the cover substrate, wherein the fourth electrode layer is located between the second optical transparent adhesive layer and the thin film layer, and the second optical transparent adhesive layer is located between the cover substrate and the fourth electrode layer.

4. The cholesteric liquid crystal display device of claim 3, wherein the third electrode layer comprises a plurality of third conductive bands, the third conductive bands are arranged in parallel, the fourth electrode layer comprises a plurality of fourth conductive bands, the fourth conductive bands are arranged in parallel, wherein the third conductive bands and the fourth conductive bands are orthogonal to each other.

5. The cholesteric liquid crystal display device of claim 3, wherein at least one of the first electrode layer, the second electrode layer, the third electrode layer, the fourth electrode layer have a metal grid structure.

6. The cholesteric liquid crystal display device of claim 1, further comprising a driving electrode, wherein the driving electrode is electrically connected to the first electrode layer and the liquid crystal module, respectively.

7. The cholesteric liquid crystal display device of claim 1, further comprising an integrated circuit element, wherein the integrated circuit element is electrically connected to the first electrode layer and the liquid crystal module, respectively.

8. The cholesteric liquid crystal display device of claim 1, wherein the filter-side substrate and the cover substrate respectively are a glass substrate, a flexible polyester substrate or a polyimide substrate.

9. The cholesteric liquid crystal display device of claim 1, wherein the filter-side substrate comprises an active matrix structure or a passive matrix structure.

10. A cholesteric liquid crystal display device, comprising:
a liquid crystal module comprising a flat layer; and
a touch module disposed on a surface of the flat layer of the liquid crystal module, the touch module comprising:
a filter-side substrate connected to the flat layer of the liquid crystal module;
a first electrode layer connected to the filter-side substrate, wherein the filter-side substrate is located between the first electrode layer and the liquid crystal module;
an optical transparent adhesive layer connected to the first electrode layer, wherein the first electrode layer is located between the optical transparent adhesive layer and the filter-side substrate;
a second electrode layer connected to the optical transparent adhesive layer, wherein the optical transparent adhesive layer is located between the second electrode layer and the first electrode layer; and
a cover substrate connected to the second electrode layer, wherein the second electrode layer is located between the cover substrate and the optical transparent adhesive layer.

11. The cholesteric liquid crystal display device of claim 10, wherein the first electrode layer comprises a plurality of first conductive bands, the first conductive bands are arranged in parallel, the second electrode layer comprises a plurality of second conductive bands, the second conductive bands are arranged in parallel, wherein the first conductive bands and the second conductive bands are orthogonal to each other.

12. The cholesteric liquid crystal display device of claim 10, wherein the filter-side substrate and the cover substrate respectively are a glass substrate, a flexible polyester substrate or a polyimide substrate.

13. The cholesteric liquid crystal display device of claim 10, wherein the filter-side substrate comprises an active matrix structure or a passive matrix structure.
